(19) United States
(12) Patent Application Publication
(10) Pub. No.: US 2014/0153775 A1
(43) Pub. Date: Jun. 5, 2014

(54) SIMILARITY DETERMINATION APPARATUS, SIMILARITY DETERMINATION SYSTEM, AND SIMILARITY DETERMINATION METHOD

(71) Applicants: Go MARUYAMA, Kanagawa (JP); Kensuke Masuda, Kanagawa (JP); Yuji Yamanaka, Kanagawa (JP)

(72) Inventors: Go MARUYAMA, Kanagawa (JP); Kensuke Masuda, Kanagawa (JP); Yuji Yamanaka, Kanagawa (JP)

(21) Appl. No.: 14/083,871

(22) Filed: Nov. 19, 2013

(30) Foreign Application Priority Data
Dec. 3, 2012 (JP) 2012-264305
Sep. 30, 2013 (JP) 2013-204755

(51) Int. Cl. G06K 9/00

(52) U.S. Cl. CPC G06K 9/00624
USPC 382/103

(57) ABSTRACT

A similarity determination apparatus, a similarity determination system, and a similarity determination method are provided, each of which calculates spectral information of an object, transforms the spectral information of the object into characteristic quantity, generates a similarity determination criterion from one or a plurality of items of characteristic quantity of a reference item, and checks the characteristic quantity of the object against the similarity determination criterion to determine similarity of the object with reference to the reference item.

### CROSS-REFERENCE TO RELATED APPLICATIONS

This patent application is based on and claims priority pursuant to 35 U.S.C. §119 to Japanese Patent Application Nos. 2012-264305, filed on Dec. 3, 2012, and 2013-204755, filed on Sep. 30, 2013, in the Japan Patent Office, the entire disclosure of which is hereby incorporated by reference herein.

### BACKGROUND

1. Technical Field

The present invention relates to a similarity determination apparatus, a similarity determination system, and a similarity determination method, in which similarity in color or the like is determined and sameness of a target item with reference to a reference item is determined.

2. Background Art

For example, in inspecting products on a manufacturing line, the colors of a product are checked by using an FA (Factory Automation) camera in which an area sensor having image capturing elements such as a CCD or a CMOS is incorporated, and a product whose color difference exceeds a certain sameness is excluded as a defective. The color determination with an FA camera uses spectral characteristics of the image capturing elements, and a determination is made according to the similarity in RGB brightness value. However, such a method is dependent on the spectral reflectance of the image capturing elements, and a slight color difference cannot be detected. Moreover, there has been a problem that accuracy in determination of a certain color is significantly low.

Further, the conventional color cameras, such as FA cameras used for color determination as described above, are designed such that the spectral sensitivity of a sensor will be similar to human visual sensation. However, the color captured by the camera differs depending on environmental illumination and a difference in positional relationship between a specimen and illumination light. This affects the determination result. For this reason, determination eventually relies upon visual inspection in some cases. If determination relies upon visual check by a person, it is inevitable that there is concern about inconsistencies of the inspection accuracy.

### SUMMARY

Example embodiments of the present invention include a similarity determination apparatus, a similarity determination system, and a similarity determination method, each of which calculates spectral information of an object from capturing information detected by an image capturing device, the object including 1) a reference item and 2) a target item being a subject for color determination, transforms the spectral information of the object into characteristic quantity, generates a similarity determination criterion from one or a plurality of items of the characteristic quantity of the reference item of the object, and checks the characteristic quantity of the target item being a subject for color determination against the similarity determination criterion to determine similarity of the target item with reference to the reference item.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings.

FIG. 1 is a schematic diagram illustrating the configuration of a similarity determination system according to an example embodiment of the present invention.

FIG. 2 is a schematic diagram for illustrating the principle of an image capturing device that serves as a plenoptic camera.

FIG. 3 is a schematic cross-sectional view illustrating the structure of an image capturing device of the similarity determination system of FIG. 1, according to an example embodiment of the present invention.

FIG. 4 is a schematic block diagram illustrating a functional structure of a processing circuit of the similarity determination system of FIG. 1, according to an example embodiment of the present invention.

FIG. 5 is a diagram illustrating the positional and rotational transformation of an image, according to an example embodiment of the present invention.

FIG. 6 is a plan view illustrating an example of the image data captured by the image capturing device of FIG. 3.

FIG. 7 is a magnified view of an example macro pixel.

FIG. 8 is a diagram illustrating an example case in which an enclosing shape encompassing characteristic quantity is circular.

FIG. 9 is a diagram illustrating an example in which an enclosing shape encompassing characteristic quantity is polygonal.

FIG. 10 is a schematic diagram illustrating the state transition of a control unit of the processing circuit, according to an example embodiment of the present invention.

FIG. 11 is a flowchart illustrating operation of the control unit in a teaching state, according to an example embodiment of the present invention.

FIG. 12 is a flowchart illustrating operation of the control unit in an operating state, according to an example embodiment of the present invention.

FIG. 13A is a flowchart illustrating operation including the user operation on a PC (personal computer) when color determination application is run in a teaching state, according to an example embodiment of the present invention.

FIG. 13B is a flowchart illustrating operation including the user operation on a PC when color determination application is run in an operating state, according to an example embodiment of the present invention.

FIG. 14 is a diagram illustrating an installed condition of a specimen and a camera, according to an example embodiment of the present invention.

FIG. 15 is a diagram illustrating an example display screen of a color determination application on a display of a PC.

FIG. 16 is a diagram illustrating a state where an image for which positional and rotational transformation has been performed is being displayed on the display of FIG. 15.

FIG. 17 is a diagram illustrating a state where coordinates for which color measurement is to be performed are selected on the display of FIG. 16.

FIG. 18 is a diagram illustrating a state where coordinates for which color evaluation is to be performed are selected on the display of FIG. 17.

FIG. 19 is a diagram illustrating a state where a determination result is displayed on the display of FIG. 19.

The accompanying drawings are intended to depict example embodiments of the present invention and should not be interpreted to limit the scope thereof. The accompanying drawings are not to be considered as drawn to scale unless explicitly noted.

### DETAILED DESCRIPTION OF THE INVENTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that operate in a similar manner.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more Central Processing Units (CPUs), digital signal processors (DSPs), application-specific-integrated-circuits, field programmable gate arrays (FPGAs) computers or the like. These terms in general may be referred to as processors.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

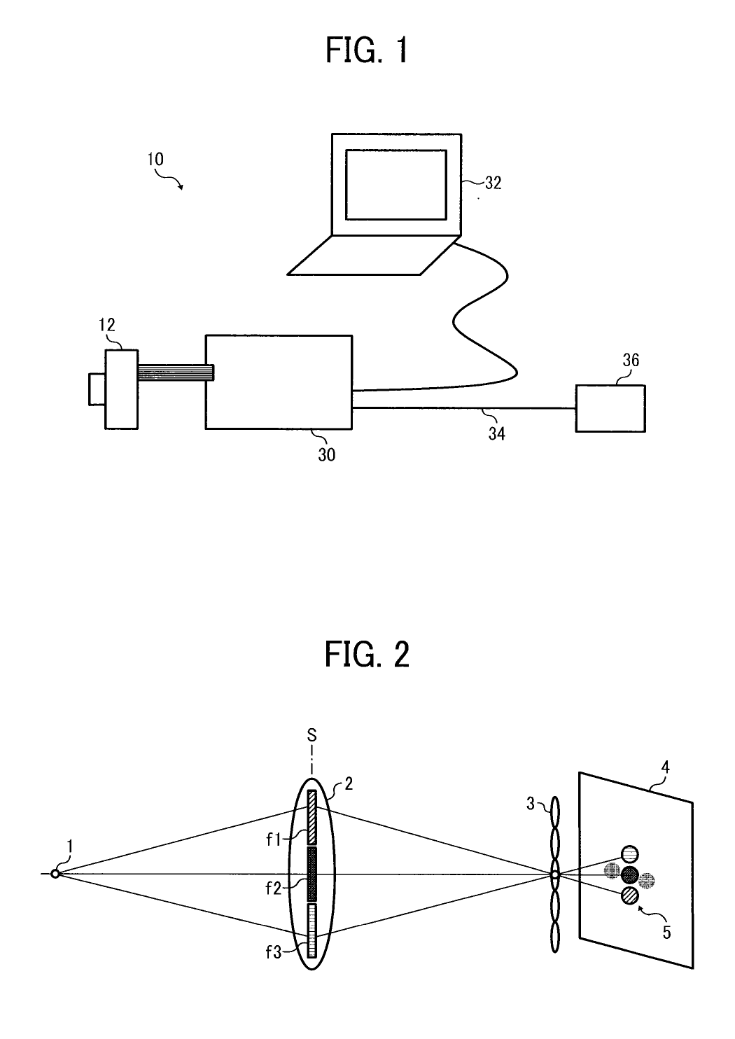

Example embodiments of the present invention will be described with reference to the drawings. FIG. 1 is a schematic block diagram illustrating a similarity determination system 10 according to an example embodiment of the present invention. The similarity determination system 10 includes an image capturing device 12 that serves as an imaging unit, a processing circuit 30, and a PC (personal computer) 32.

An image obtained by an image capturing element of the image capturing device 12 is transferred to the processing circuit 30. The processing circuit 30 performs processing on the image captured by the image capturing device 12, such as computation for color determination or image processing. The PC 32, which is capable of communicating with the processing circuit 30, designates a parameter for image processing, displays the captured image, or displays a result of the processing performed by the processing circuit 30.

Alternatively, a dedicated terminal with a touch panel or the like may be provided instead of the PC 32. Further, the PC 32 may be integrated with at least a part of the processing circuit. In other words, a terminal such as a PC may include at least a part of the functions of the processing circuit. The processing circuit 30 communicates with an external device 36 through an external communication line 34. For example, the external device 36 is capable of giving a capturing instruction (capturing trigger) to the processing circuit 30, monitoring the operating state of the processing circuit 30, and receiving a determination result from the processing circuit 30. Generally, the processing circuit 30 is connected to a PLC (Programmable logic controller), which is one example of the external device 36.

The image capturing device 12 may be implemented by a light field camera (plenoptic camera). Before the configuration of the image capturing device 12 is specifically described, the principle of a plenoptic camera will be described with reference to FIG. 2. Here, an optical system 2 that serves as the first optical system will be illustrated as a single lens, and the center of the single lens is illustrated as a stop position S of the optical system 2, so as to describe the principle of functions in a simple manner. In the center of the single lens 2, three types of filters f1 (R: red), f2 (G: green), and f3 (B: blue) are arranged. For simplicity, FIG. 1 illustrates the filters f1 to f3 as they are positioned inside the lens 2 in FIG. 1. It is to be noted that the actual positions of the filters are not within the lens, but near the lens.

Near a focusing position of the single lens 2, a microlens array 3 (hereinafter, this will be referred to as “MLA” 3) that serves as the second optical system is arranged. In an image area 4 of FIG. 2, a sensor 5 that serves as an image capturing element is arranged. The sensor 5 converts the optical information of the lights focused on the image area 4 by the optical system, into electronic information. The MLA 3 is a lens array in which a plurality of lenses are arranged substantially in parallel to a two-dimensional plane surface of the image capturing element. Here, it is assumed that the sensor 5 is a monochrome sensor, such that the principle of a plenoptic camera will be understood easily.

The lights diffused from a point of an object 1 enter different positions on the single lens 2, and pass through the filters f1 to f3 that have different spectral characteristics depending on the position on the single lens 2. The lights that have passed through the filter form an image near the MLA 3, and the respective lights are then irradiated by the MLA 3 onto different positions of the sensor 5. As lights having different spectral characteristics that originate from a certain point are irradiated onto different positions of the sensor 5, it becomes possible to project a plurality of types of spectral information on the sensor 5 at once.

The spectral information of a position of the object 1, which is different from the position of the above point, is also irradiated onto different positions of the sensor 5 in a similar manner as described above. This process is performed for a plurality of points of the object, and image processing is applied to arrange the spectral information in order by spectral characteristics. By so doing, two-dimensional images of different spectral characteristics may be obtained at once. If this principle is applied, the two-dimensional spectrum of an object may be obtained in real time (instantly) by arranging a plurality of band-pass filters near the stop of the single lens 2.

Here, the phrase “near the stop” includes a stop position, and indicates a region through which light rays with various angles of view can pass. There are cases in which a plurality of filters having different spectral characteristics provide the function of a filter according to one example of the present invention, and there are cases in which a plurality of filter areas having different spectral characteristics provide the function of a filter according to one example of the present invention. In the former cases, the filter is configured by connecting or combining a plurality of filters with each other. In the latter cases, spectral characteristics are different for the respective areas in a single unit of filter.

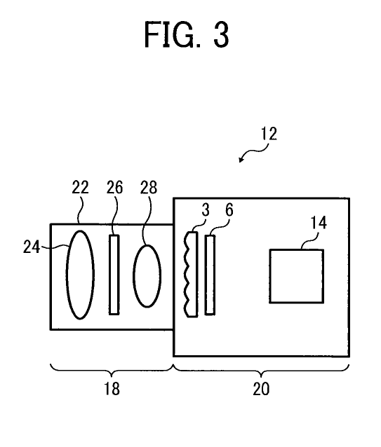

The configuration of the image capturing device (hereinafter, this will be referred to simply as “camera”) 12 will be specifically described with reference to FIG. 3. The image capturing device 12 is provided with a lens module 18 and a camera unit 20, and the camera unit 20 includes an FPGA (Field-Programmable Gate Array) 14. The FPGA 14 functions as a spectral image generator that generates a plurality of kinds of spectral images based on the spectral information obtained by the image capturing device 12. The FPGA 14 may be provided outside the image capturing device 12. When the FPGA 14 is provided separately from the image capturing device 12, the FPGA 14 may be integrated with the processing circuit 30. In one example, the FPGA 14 may be implemented by a processor such as a central processing unit (CPU), and a memory. The processor may be caused to perform at least a part of the functions provided by the processing circuit 30.

The lens module 18 includes a lens-barrel 22, a main lens 24 provided inside the lens-barrel 22 that serves as the first optical system, a filter 26 arranged near the stop of the main lens 24, and a lens 28.

The camera unit 20 includes an MLA 3 that serves as the second optical system, a monochrome sensor 6 (hereinafter, this will be referred to simply as “sensor” 6) that serves as an image capturing element, and the FPGA 14 therein. A plurality of microlenses are arranged on the MLA 3 in two-dimensional directions perpendicular to an optical axis of the main lens 24. Note that microlenses are implemented on a sensor for every one pixel, which is different from the MLA 3. General color sensors are provided with RGB color filters for every pixel in a Bayer array.

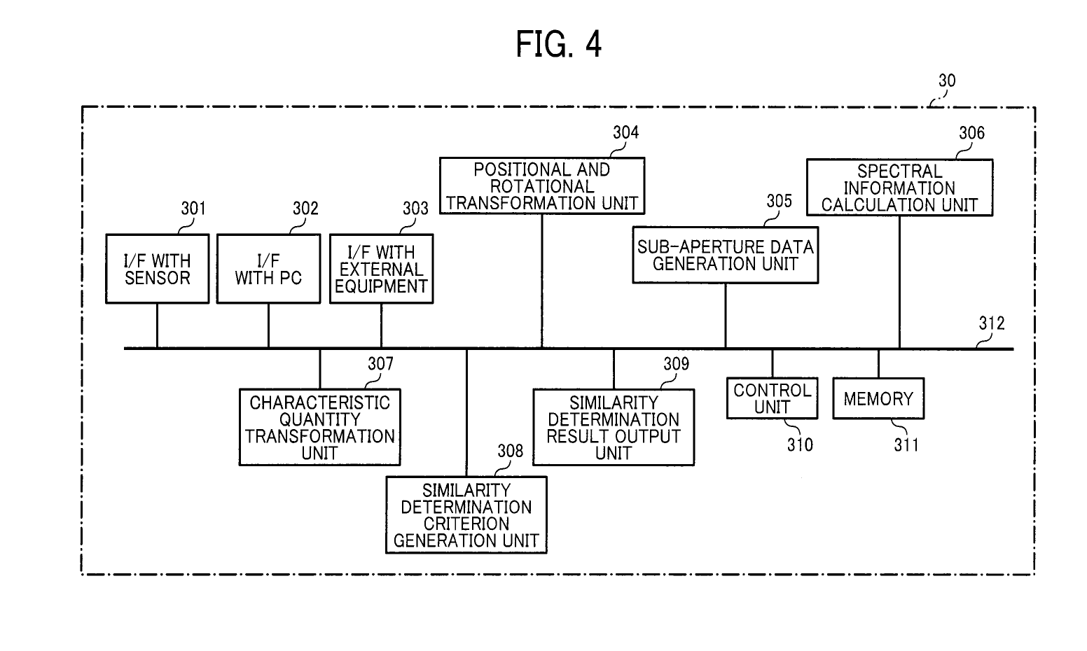

A general outline of modules that constitute the processing circuit 30 will be described with reference to FIG. 4. A reference sign “301” indicates an I/F (interface) with the sensor 6 of the image capturing device 12. The I/F 301 transmits data indicating the setting of the sensor 6 that is received from a control unit 310 to the sensor, and transfers the image data output from the sensor 6 to a sub-aperture data generation unit 305. A reference sign “302” indicates an I/F with the PC 32, and the I/F 302 receives a user setting value set at the PC 32 and sends a determination result or image data to the PC 32. A reference sign “303” indicates an I/F with external equipment, and the I/F 303 performs various operation such as receiving a capturing trigger from external equipment, outputting the operating state of the processing circuit 30, and outputting a determination result.

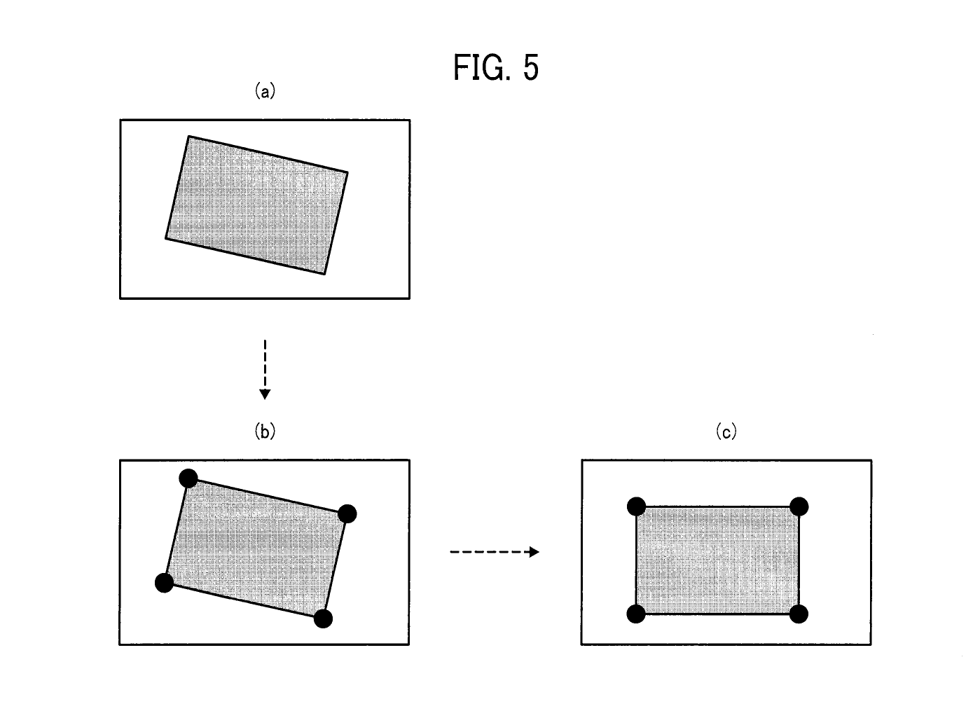

A reference sign “304” indicates a positional and rotational transformation unit, and the positional and rotational transformation unit 304 performs positional transfer and rotational transfer on an image captured by the sensor 6. For example, when an image is obtained (image is captured) as illustrated in FIG. 5(a), four vertices (i.e., filled circles) are detected (image is detected) from the image as illustrated in FIG. 5(b). Then, as illustrated in FIG. 5(c), positional transfer and rotational transfer are performed such that the four vertices will be moved to a predetermined position of the screen (position-rotated image). This process is performed to reduce an error caused when the position of a specimen captured by the image capturing device 12 differs from the position of the specimen displayed on a screen. When it is possible to additionally prepare a mechanism that always arranges an image at the same position, such a process is not necessary.

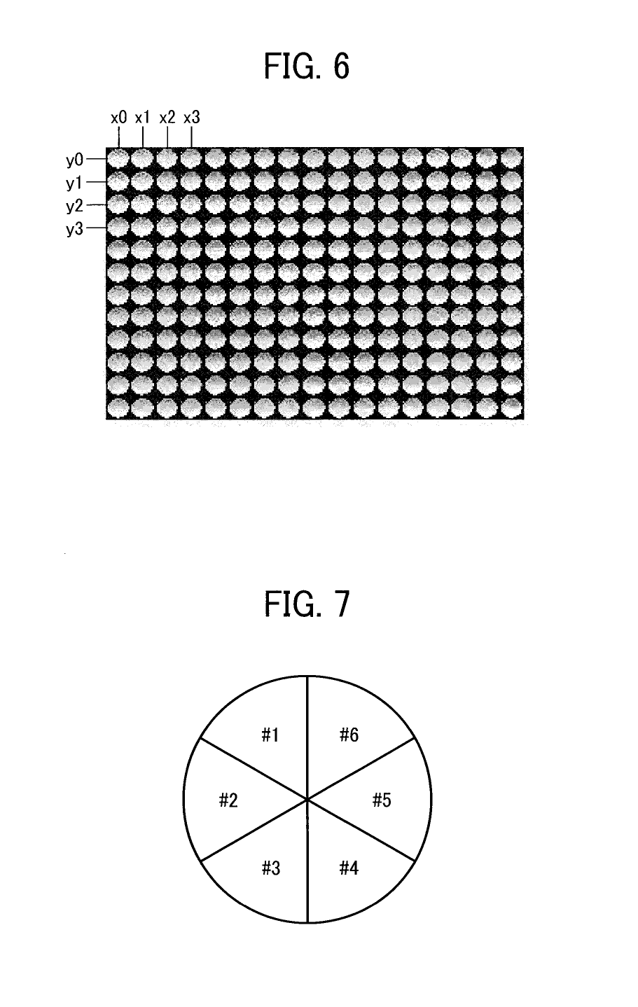

In FIG. 4, a reference sign “305” indicates the sub-aperture data generation unit, and the sub-aperture data generation unit 305 generates sub-aperture data from the capture data obtained by the sensor 6. FIG. 6 is a diagram illustrating the correspondence relation between the image data and the sub-aperture data. As illustrated in FIG. 6, the image data consists of small circles. The shape is circular because the shape of the stop of the main lens 24 is circular. Each of these small circles will be referred to as a “macro-pixel”. The macro-pixels are respectively formed below the small lenses that constitute the MLA 3.

Indexes are provided in X-direction (horizontal direction: x0, x1, x2, . . . ) and Y-direction (vertical direction: y0, y1, y2, . . . ) on each macro-pixel, which will be referred to as a coordinate system of sub-aperture data. In an example embodiment of the present invention, the number of macro-pixels correspond to the number of coordinate values (x, y) of the coordinate system of sub-aperture data on a one-to-one basis. However, the correspondence is not limited to this example, such that one-to-two relation or the like is also possible. The process of obtaining N-band data that corresponds to each spectral filter of a macro-pixel from the pixel data of the macro-pixel will be referred to as the calculation of band data. The calculation in an example embodiment of the present invention conceptually includes calculating an average value from a plurality of pieces of pixel data and obtaining one piece of pixel data. N-dimensional band data that is calculated from macro-pixels and is two-dimensionally arranged in X-direction and Y-direction will be referred to as sub-aperture data.

The procedure for generating sub-aperture data will be described in detail. FIG. 7 is a magnified view of a macro-pixel. In this example, a macro-pixel is divided into six areas that respectively correspond to the spectral filters, as illustrated in FIG. 7. Each of these areas will be herein referred to as a “meso-pixel”. A macro-pixel and meso-pixels are captured across a plurality of pixels on image data, that is, on the pixels of the sensor 6. Band data that corresponds to each band of each macro-pixel is calculated by using a plurality of pixels that form meso-pixels of that macro-pixel.

For example, referring to FIG. 7, the value of the band data that corresponds to a #1 band-pass filter, i.e., #1 band data, is calculated by calculating an average of the brightness values of a plurality of pixels on the image data that corresponds to the meso-pixel. An average is calculated in the above, but the example embodiments are not limited to such example. For example, as described above, the brightness value of one pixel included in a meso-pixel may just be regarded as band data. The same can be said for #2 to #6.

When the data of the six bands of the top-left macro-pixel (x0, y0) of FIG. 6 is obtained, such a process is equivalent to the process of obtaining the data that corresponds to the meso-pixels that form the macro-pixel. The data of the six bands of the other macro-pixels are obtained, and the obtained band data is two-dimensionally arranged in X-direction and Y-direction, in a similar manner as described above. Accordingly, sub-aperture data is generated.

In FIG. 4, a reference sign “306” indicates a spectral information calculation unit, and the spectral information calculating unit 306 calculates the spectral information of an object from the capturing information detected by the image capturing device 12. The spectral information calculation unit 306 calculates spectral information (i.e., high-dimensional spectral information) of a coordinate value (x, y) from the sub-aperture data obtained by the sub-aperture data generation unit 305. In this example, the method disclosed in Yoichi MIYAKE, Introduction to Spectral Image Processing, University of Tokyo Press, 2006, Chapter 4 may be applied to estimate high-dimensional spectral information (i.e., continuous spectral reflectance) from low-dimensional information (i.e., six-band data).

This method will be described below. Firstly, a spectral reflectance estimation problem is formulated. The spectral reflectance estimation problem is expressed as Equation (1).

g=S^{t}Er+n (1)

In Equation (1),

g: column vector of m*l indicating each piece of band data,

r: column vector of l*1 indicating the spectral reflectance of an object, and

S: matrix of l*m, where an I-th column indicates the spectral sensitivity characteristics of I-th band. Top-right superscript “t” indicates the transposition of the matrix.

E: diagonal matrix of l*1, where the diagonal component indicates the spectral energy distribution of illumination, and

n: noise term.

In this example, it is assumed that “m=6”. “l” indicates the number of samples of the wavelength of spectral reflectance to be calculated. For example, when sampling is performed at 10 nm intervals in a wavelength area of 400-700 nm, the number of samples becomes “31”. Assuming that H=S^{t}E, Equation (1) may be summarized as the following linear system (Equation (2)).

g=Hr+n (2)

“H” is referred to as a system matrix. Spectral reflectance r of an object is calculated from band data g, but when m<l as in this example of the present invention, there would be infinite number of solutions that satisfy Equation (2) and the solution cannot uniquely be determined. Such a problem is generally referred to as an ill-posed problem. A least-norm solution is one of the solutions that is often selected in an ill-posed problem. When it is possible to ignore noise in Equation (2), a least-norm solution is expressed as Equation (3) as follows.

\hat{r}=H^{t}(HH^{t})⁻¹g (3)

The least-norm solution calculated in Equation (3) is a continuous spectral reflectance, and the least-norm solution turns out to be the spectral data obtained by the spectral information calculation unit 306. In addition to the least-norm solution, a method using principal component analysis or a method using Wiener estimation has already been proposed for an ill-posed problem, for example, in MIYAKE reference. These methods may also be used. In view of the spectral reflectance estimation accuracy, it is preferable to use Wiener estimation.

In FIG. 4, a reference sign “307” indicates a characteristic quantity transformation unit. The characteristic quantity transformation unit 307 transforms the spectral information obtained by the spectral information calculation unit 306, thereby outputting the characteristic quantity of a color that corresponds to the coordinate value (x, y). In this example embodiment of the present invention, only a method for transforming spectral information into an L*a*b* colorimetric system will be described, but various other methods such as the other CIE (International Commission on Illumination) colorimetric systems or other colorimetric systems may also be used. Alternatively, N-dimensional spectral information may be output just as it is without any transformation.

A procedure for transforming the spectral data (i.e., spectral reflectance) obtained by the spectral information calculation unit 306 into the characteristic quantity of color space coordinates (i.e., brightness L*, and chromaticity a* and b* of L*a*b* colorimetric system in this example embodiment of the present invention) will be described. In addition to spectral reflectance, data such as color matching functions and the spectral intensity of illumination is used. As color matching functions, the following functions that are specified by the CIE are generally used.

x̅(λ), y̅(λ), z̅(λ)

As the spectral intensity of illumination, the spectral intensity of illumination in an environment in which an object is observed is to be used, but a standard light source (such as A-light source and D65 light source) that is defined by the CIE may also be used.

Next, tristimulus values X, Y, and Z are calculated by using Equation (4) below. In Equation (4), E(λ) indicates the spectral distribution of a light source, and R(λ) indicates the spectral reflectance of an object.

X=∫E(λ) x̅(λ)R(λ)dλ

Y=∫E(λ) y̅(λ)R(λ)dλ

Z=∫E(λ) z̅(λ)R(λ)dλ (4)

Brightness L*, and chromaticity a* and b* are calculated from the tristimulus values by using Equation (5) below.

L*=116f(Y/Yₙ)−16

a*=500[f(X/Xₙ)−f(Y/Yₙ)]

b*=200[f(Y/Yₙ)−f(Z/Zₙ)] (5)

where

$$f ( t ) = \{ \begin{matrix}{t}^{1 \text{/} 3} & t > {( 6 / 29 )}^{3} \\ \frac{1}{3} {( \frac{29}{6} )}^{2} t + \frac{4}{29} & otherwise\end{matrix}$$

In Equation (5), Xn, Yn, and Zn indicate tristimulus values of a perfectly diffuse reflector. Spectral data is converted into characteristic quantity (L*a*b*) by following the procedure as above.

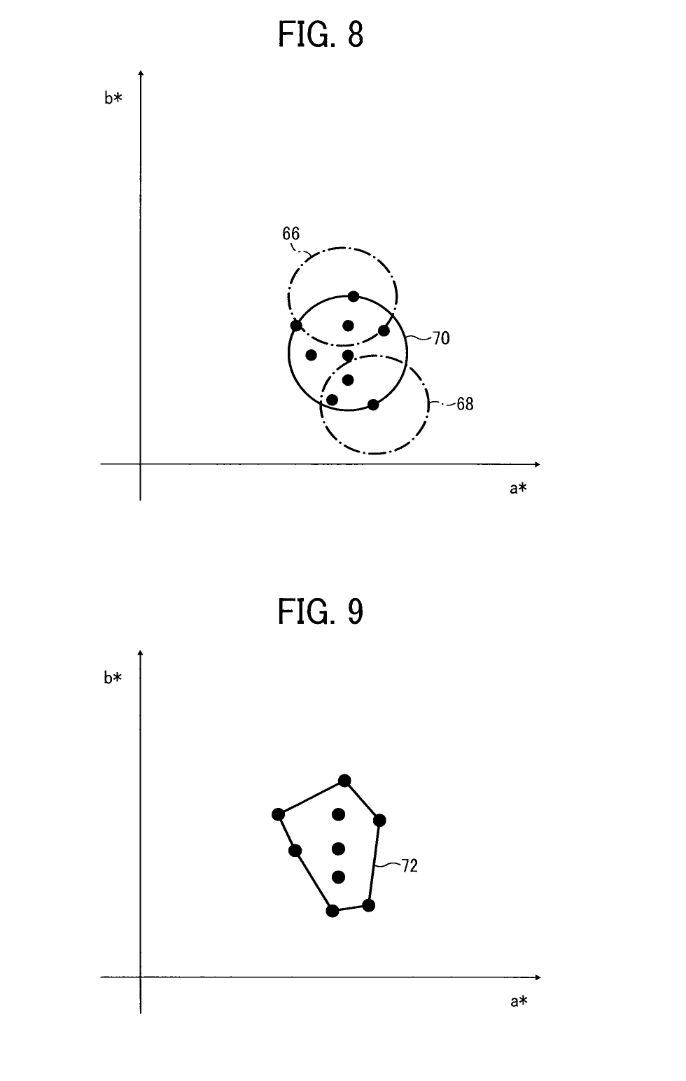

In FIG. 4, a reference sign “308” indicates a similarity determination criterion generation unit. The similarity determination criterion generation unit 308 receives an instruction from the control unit 310, and generates a determination criterion for determining similarity. In the example embodiment of the present invention, only the a*b* components of the N items of L*a*b* value that are output from the characteristic quantity transformation unit 307 are used, and a circle of enclosing shape that includes all the N vertices obtained from a boundary sample is determined to be a similarity determination criterion. Here, a circle with the smallest radius is determined to be a similarity determination criterion. A concrete example will be described with reference to some drawings. FIG. 8 is a drawing illustrating the distribution of a*b*value where N=9. The smallest C that satisfies (x−a1)²+(y−b1)²≦C and the values for a1 and b1 at that time are calculated for the nine vertices (x, y) indicated by filled circle, i.e., a smallest, minimum inclusion circle 70 with the smallest radius. Note that one example method for calculating a set of a1, b1, and C is disclosed in Kiyoshi ISHIHATA, Sphere Including Set of Points, IPSJ Magazine Vol. 43 No. 9 September 2002, pp. 1009-1015, Information Processing Society of Japan, which is hereby incorporated by reference herein.

Cases in which the vertices are placed within the minimum inclusion circle 70 are classified as “OK” (meaning “similar” or “some sameness is present”), and the other cases are classified as “NG” (meaning “not similar” or “no sameness is present”). Generally, there is more than one kind of boundary sample, and the minimum inclusion circle 70 is formed from the data obtained from these boundary samples (i.e., characteristic quantity). For example, even when there are other data areas 66 and 68 of a boundary sample, any area that is not within the minimum inclusion circle 70 is classified as “NG”. If a probability of determining “NG” to be “OK” is to be further reduced, the calculated “C” may be multiplied by a coefficient that makes a determination criterion stricter, for example, “0.9”. When the given sample data is stricter in a sample than one in practical use (sample having small degree of dispersion), a little broader area may be set to an OK area by multiplying the calculated “C” by a coefficient such as “1.1”.

Note that an enclosing shape is not limited to a circle, and an enclosing shape may be a polygon including N vertices (i.e., convex polygon in this example embodiment of the present invention). A method for calculating such a convex polygon includes, for example, a method as follows. Two vertices i and j are selected from N vertices, and a straight line that passes through these two points is calculated by an equation as follows.

y−yj−(yi−yj)/(xi−xj)*(x−xj)=0

Then, calculation is made to determine on which side of the straight line N vertices are placed. When N vertices are all placed on a same side, the straight line that connects between vertices (x1, y1) and (x2, y2) is registered. FIG. 9 illustrates an example of a polygon 72 that encompasses N (i.e., 9 in FIG. 9) vertices. There are a plurality of kinds of boundary samples, which is the same as above.

In an example embodiment of the present invention, examples have been described in which an enclosing shape, which is a conceptual form that includes characteristic quantity, is a two-dimensional minimum inclusion circle or polygon. However, no limitation is indicated for the present invention. When characteristic quantity is N-dimensional, an enclosing shape may be an N-dimensional sphere, or an N-dimensional polyhedron (N-dimensional convex polyhedron) such as a columnar body and a spindle-shaped body.

In FIG. 4, a reference sign “309” indicates a similarity determination result output unit. The similarity determination result output unit 309 checks the similarity determination criterion (enclosing shape) obtained by the similarity determination criterion generation unit 308 against M input values. Then, the similarity determination result output unit 309 determines the M input values to be “OK” when all the M input values are within the similarity determination criterion, and determines the M input values to be “NG” in the other cases. In other words, when even one item of the input characteristic quantity is not within the similarity determination criterion, such a case is determined to be “NG”.

In FIG. 4, a reference sign “310” indicates a control unit, and the control unit 310 instructs modules to operate according to a state of the control unit 310. For example, the control unit 310 is implemented by a processor such as the CPU. A reference sign “311” indicates a memory, and the memory 311 is a general term for a nonvolatile or volatile memory in which data is stored as necessary. A reference sign “312” indicates a bus, and the bus 312 is a path through which data is exchanged among modules.

In this example, any of the above-described units or modules shown in FIG. 4 can be implemented as a hardware apparatus, such as a special-purpose circuit or device, or as a hardware/software combination, such as a processor executing a software program. In one example, the modules of the processing circuit 30 may be carried out by a processor (such as the control unit 310) that executes the color determination application program, which is loaded onto the memory (such as the memory 311). The color determination application program may be previously stored in the memory, downloaded from the outside device via a network, or read out from a removable recording medium.

Further, the modules of the processing circuit 30 may be implemented in various ways. In one example, the modules of the processing circuit 30 shown in FIG. 4 may be implemented by a control unit of an apparatus incorporating the image capturing device 12. In such case, the control unit, such as the FPGA 14 implemented by the processor and the memory, is programmed to have the functional modules shown in FIG. 4, for example, by loading a color determination application program stored in the memory. In such case, the apparatus, such as the image capturing apparatus having the image capturing device 12, functions as an apparatus capable of performing color similarity determination.

In another example, the modules of the processing circuit 30 shown in FIG. 4 may be implemented by a plurality of apparatuses, which operate in cooperation to perform color similarity determination, for example, according to the color determination application program. For example, some of the modules shown in FIG. 4 may be implemented by an apparatus including the processing circuit 30 and the image capturing device 12, and the PC 32, which are communicable via the I/F 303. For example, the I/F 301, the I/F 302, the I/F 303, the positional and rotational transformation unit 304, and the sub-aperture data generation unit 305 may be implemented by the apparatus including the image capturing device 12. The spectral information calculation unit 306, the characteristic quantity transformation unit 307, the similarity determination criterion generation unit 308, and the similarity determination result output unit 309 may be implemented by the PC 32. In such case, an image capturing system including the apparatus having the image capturing device 12 and the PC functions as a system capable of performing color similarity determination.

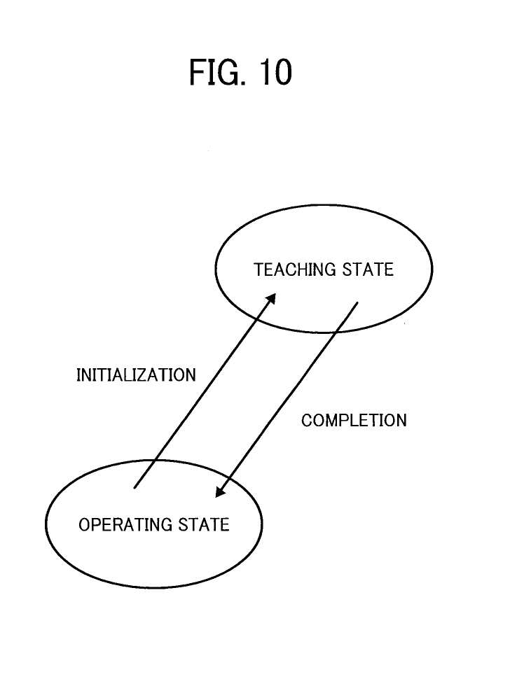

FIG. 10 is a state transition diagram of the control unit 310. The control unit 310 operates differently depending on the state. Initially, the control unit 310 is in a teaching state. When a completion signal is input in the teaching state, the control unit 310 transitions to an operating state. Here, the “teaching state” indicates a state in which the data of a boundary sample is obtained and an enclosing shape such as the minimum inclusion circle 70 is defined as a determination criterion. The “operating state” indicates a state in which determination is made by using the defined enclosing shape. Note that the state transitions to the teaching state when an initializing signal is input.

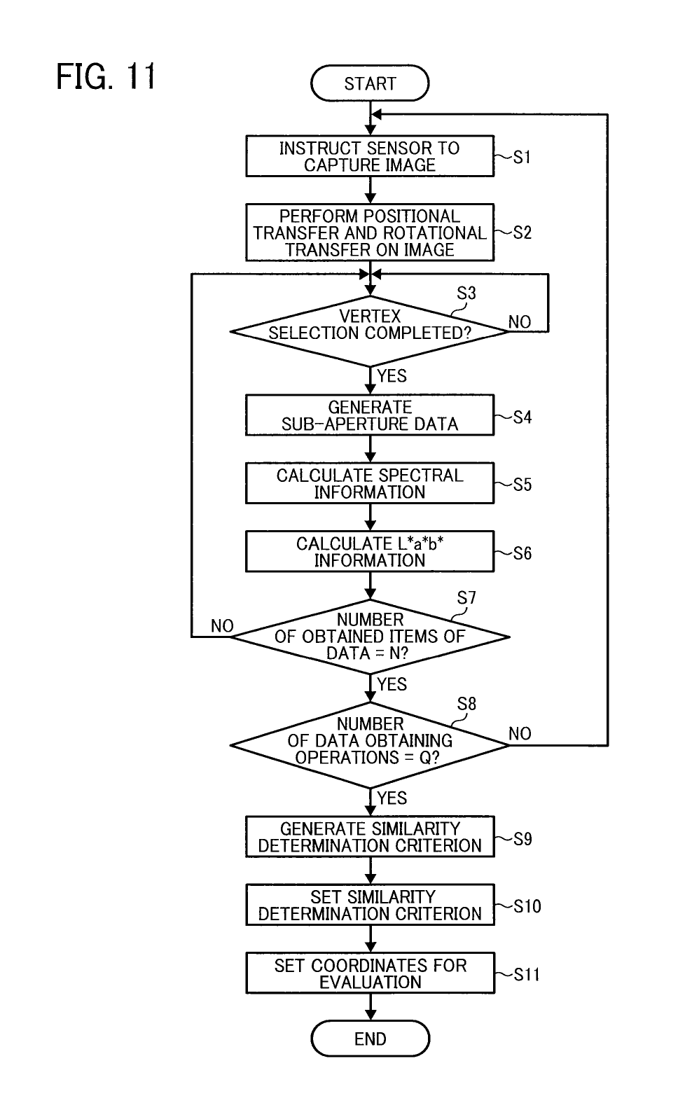

Operations in a teaching state, performed by the control unit 310, will be described with reference to FIG. 11. The control unit 310 instructs a sensor, such as the sensor 6, to capture an image (S1). Then, the image captured by the sensor (i.e., brightness image) is transferred to the positional and rotational transformation unit 304 via the I/F 301, and positional transfer and rotational transfer are performed on the image (S2).

The control unit 310 sequentially selects N coordinates (x1, y1), (x2, y2), . . . and (xn, yn) stored in the memory 311 (S3), and performs processes as follows.
The control unit 310 instructs the sub-aperture data generation unit 305 to generate sub-aperture data that corresponds to the selected coordinates (S4).
The control unit 310 instructs the spectral information calculation unit 306 to transform the sub-aperture data into spectral information (S5).
The control unit 310 instructs the characteristic quantity transformation unit 307 to transform the spectral information into L*a*b*information (S6).

Next, the control unit 310 determines whether or not the number of the obtained items of data has reached N (S7), and when it has not reached N, the process returns to S3. N as the number of the obtained items of data indicates the number of the obtained items at different points of a boundary sample, but N may indicate the number of the obtained items at the same area (the same applies to the description below). When the number of the obtained items of data has reached N, the control unit 310 repeats the above data obtaining operation until the number of times of the operation reaches a prescribed number (i.e., Q). It is preferred that “Q” be equal to or greater than the number of boundary samples.

The control unit 310 determines whether or not the number of data obtaining operations has reached Q (S8), and when it has reached Q, the control unit 310 instructs the similarity determination criterion generation unit 308 to generate a similarity determination criterion from N*Q coordinate, L*a*b*information (S9). Then, a similarity determination criterion is stored in the memory 311 (S10). Finally, M points of coordinates for evaluation are recorded according to an operation made at a PC, such as the PC 32, or the like (S11).

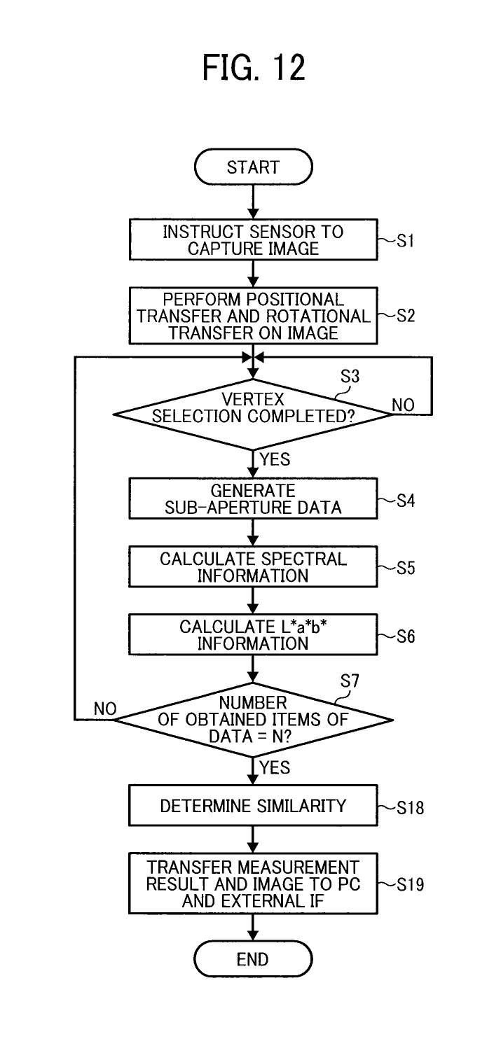

Operations in the operating state, performed by the control unit 310, will be described with reference to FIG. 12. The control unit 310 instructs a sensor, such as the sensor 6, to capture an image of an object to be determined (i.e., specimen) (S1). Then, the image captured by the sensor (i.e., brightness image) is transferred to the positional and rotational transformation unit 304 via the I/F 301, and positional transfer and rotational transfer are performed on the image (S2).

The control unit 310 sequentially selects M coordinates stored in the memory 311 (i.e., coordinates set in S11 of FIG. 11), i.e., (x1, y1),(x2, y2), . . . and (xm, ym) (S3), and performs processes as follows.
The control unit 310 instructs the sub-aperture data generation unit 305 to generate sub-aperture data corresponding to coordinates (S4).
The control unit 310 instructs the spectral information calculation unit 306 to transform the sub-aperture data into spectral information (S5).
The control unit 310 instructs the characteristic quantity transformation unit 307 to transform the spectral information into L*a*b*information (S6). Next, the control unit 310 determines whether or not the number of the obtained items of data has reached N (S7), and when it has not yet reached N, the process returns to S3.

Next, the control unit 310 instructs the similarity determination result output unit 309 to determine similarity of the L*a*b*information of the respective M coordinates (S8). Then, a determination result of “OK” is output when all the M points meet a criterion, and a determination result of “NG” is output in the other cases, via a PC such as the PC 32, or an external IF (S9).

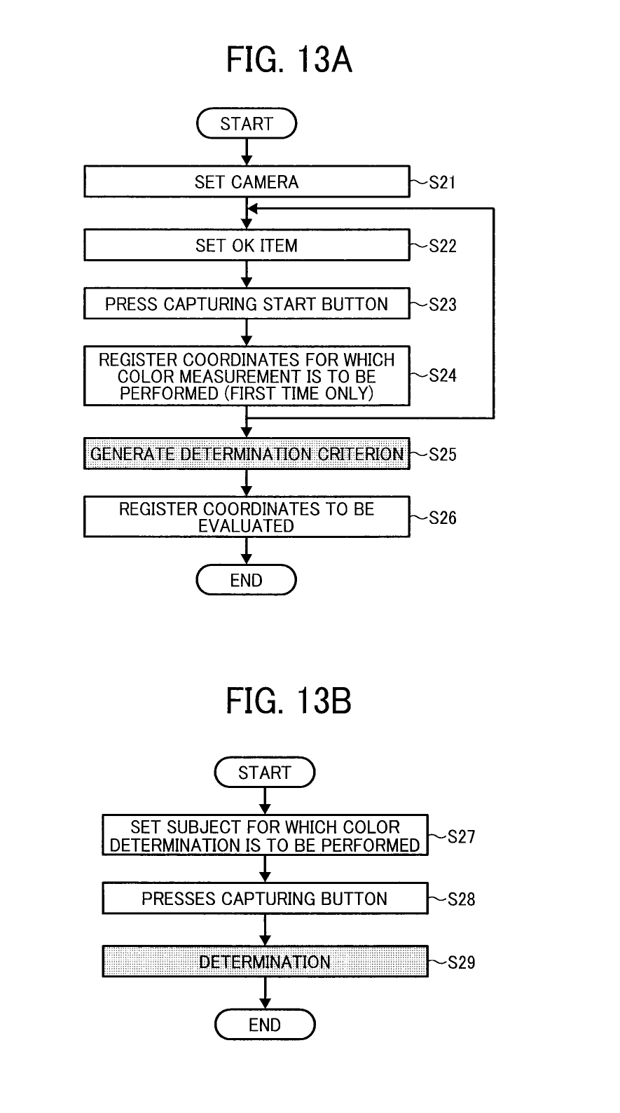

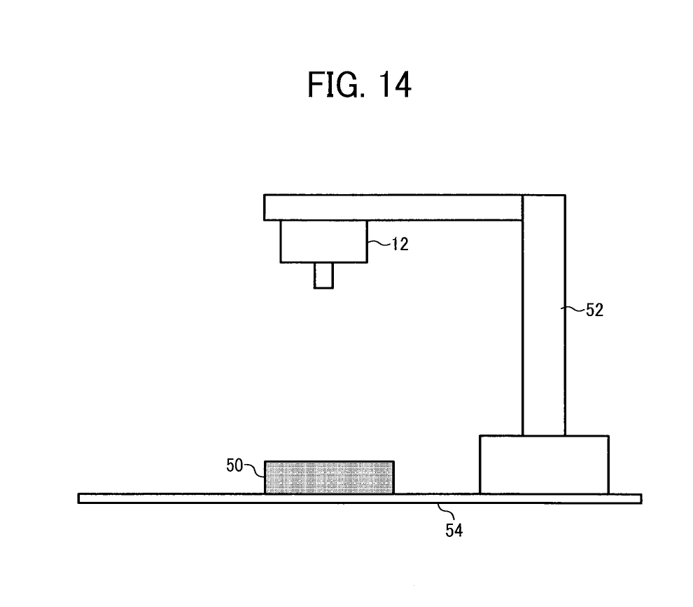

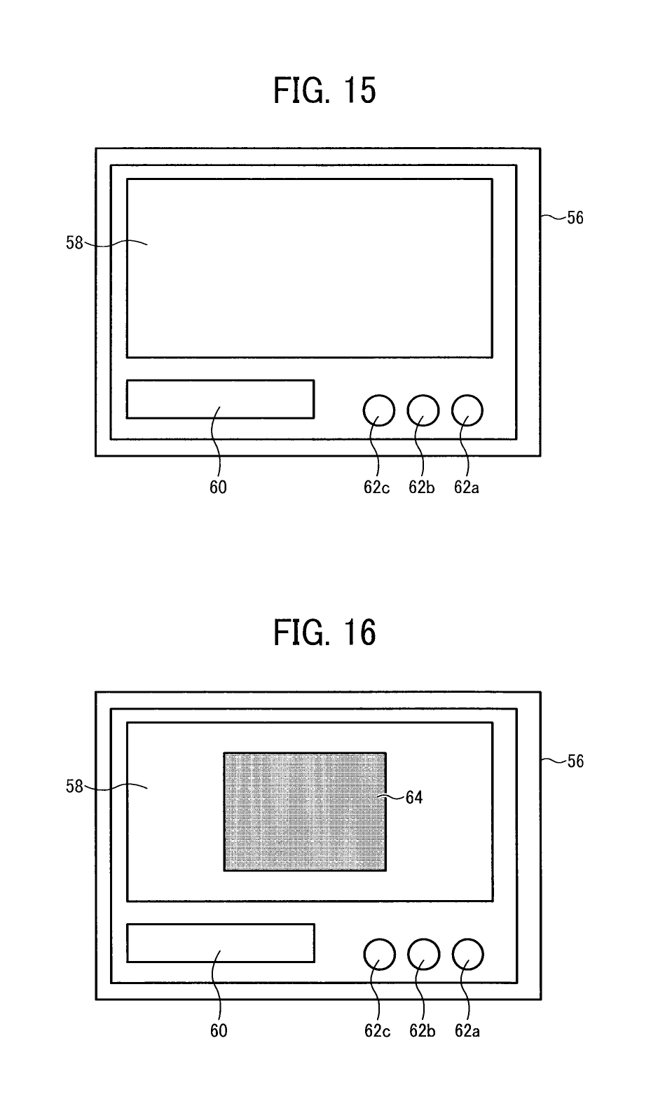

FIGS. 13A and 13B (FIG. 13) are a flowchart illustrating user operations on the PC 32 when the color determination application (hereinafter, this may be referred to simply as “application”) is run on the processing circuit 30. FIG. 14 is a diagram illustrating the installed condition of a specimen and the camera 12. FIG. 15 is a diagram illustrating the display screen of the color determination application, displayed on a display of the PC 32. The flow of user operations performed when an OK item is registered by using a color determination application will be described with reference to FIGS. 13, 14, and 15. In FIG. 13, the points that are not shaded are installed and set by a user.

### [Operations in Teaching State]

Firstly, a user fixes the camera 12 onto a support base 52 as illustrated in FIG. 14

(S21). At that time, the camera 12 is set so as to be in parallel to an installation ground 54 of the support base 52. As a result, the camera 12 is installed in a vertical direction. Note that it is assumed that the control unit 310 is in a teaching state.

Next, an OK item (i.e., reference item; specimen 50A) among the items for which color determination is to be performed is set directly below the camera (S22). At that time, the specimen 50A is set so as to be included in the field of the camera 12. When the setting is complete, the PC 32 starts a dedicated application such as the color determination application, for example, according to a user instruction input on the PC 32. FIG. 15 illustrates the display of such a dedicated application. In FIG. 15, a reference sign “56” indicates a display of the PC, and a reference sign “58” indicates a captured-image display area. A reference sign “60” indicates a determination result display area, and a reference sign “62a” indicates a capturing start button. A reference sign “62b” indicates a coordinate selecting button, and a reference sign “62c” indicates a checked-coordinate registration button.

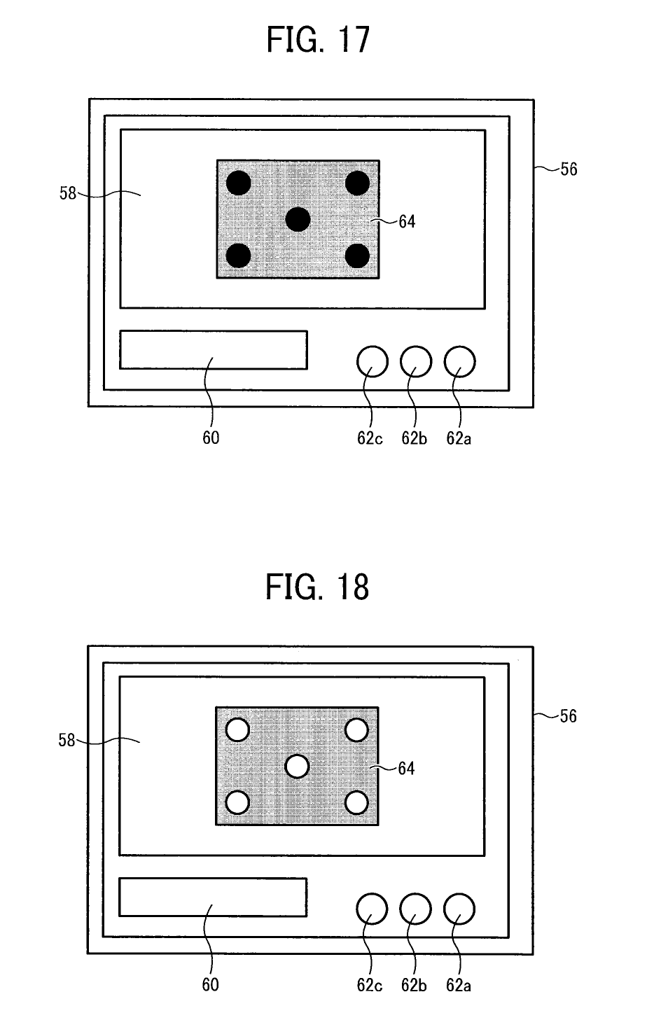

A user presses the capturing start button 62a (S23). By so doing, a capturing instruction is input to the control unit 310 through the I/F 302 with the PC. As a result, the processing circuit 30 performs S1 and S2 among the operations illustrated in FIG. 11, and the captured image on which positional and rotational transformation has been performed is output to the PC 32. As illustrated in FIG. 16, a captured image 64 is displayed on the captured-image display area 58. After the coordinate selecting button 62b is pressed (S23), a user clicks on the captured-image display area 58 by using a mouse or the like, and selects coordinates for which color measurement is to be performed as indicated by the five filled circles in FIG. 17. When the coordinate selecting button 62b is pressed again, the coordinates are recorded in the memory 311 via the I/F 302 with the PC (S24). The operation illustrated in FIG. 11 is resumed, and steps S3 to S6 become completed.

Next, a user repeats the following operations as necessary. An OK item (i.e., the specimen 50A) among the items for which color determination is to be performed is set directly below the camera (S22). At that time, the specimen 50A is set so as to be included in the field of the camera 12. When the setting is complete, a user presses the capturing start button 62a (S23). By so doing, a capturing instruction is input to the control unit 310 through the I/F 302 with the PC. As a result, the processing circuit 30 performs S1 and S2 among the operations illustrated in FIG. 11, and the captured image on which positional and rotational transformation has been performed is output to the PC and is displayed by using an application (see FIG. 16). As the user has already selected the coordinates, the coordinates for which color measurement is to be performed are displayed (see the five points illustrated as filled circles in FIG. 17).

When the coordinate selecting button 62b is pressed again, the coordinates are recorded in the memory 311 via the I/F 302 with the PC. Then, the operation illustrated in FIG. 11 is resumed, and steps S3 to S6 become completed. When a sufficient number of OK items are set, a user presses the coordinate selecting button 62b. By so doing, steps S7 and S8 of FIG. 11 become completed (S25). Next, a user presses the checked-coordinate registration button 62c. Coordinates for which color evaluation is to be performed are specified as indicated by open circles in FIG. 18. Then, the checked-coordinate registration button 62c is pressed again, and the registration of coordinates to be evaluated is completed (S26). As the registration of the coordinates to be evaluated is completed, the control unit 310 transitions from a teaching state to an operating state.

### [Operation in Operating State]

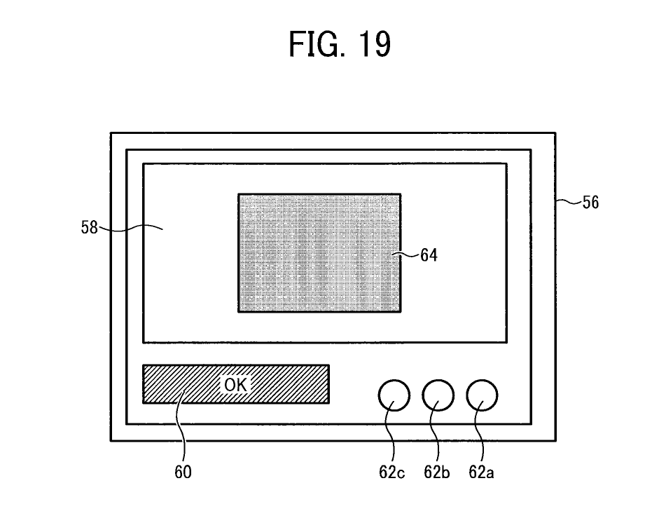

A user sets a specimen 50B as a subject (for which color determination is to be performed) so as not to change the set position in a teaching state (S27). At that time, the specimen 50B is set so as to be included within the field of the camera 12. Once the setting is complete, a dedicated application such as the color determination application (operating state mode) is operated by the PC 32. An example of the screen of such a dedicated application is illustrated in FIG. 19.

The user presses the capturing start button 62a (S28). By so doing, a capturing instruction is input to the control unit 310 via the I/F 302 with the PC, and all the operation illustrated in FIG. 12 is performed. Then, the transferred determination result is displayed on the determination result display area 60. In an example embodiment of the present invention, the fact that the determination result was OK, i.e., the fact that the specimen 50B is included within an area of sameness (identity or similarity) with reference to the specimen 50A, is displayed for example. When the specimen 50B is not included within the area of sameness, “NG” is displayed on the determination result display area 60 as the determination result.

Any one of the above-described steps of any one of the operations shown above may be performed in various other ways, for example, in a different order.

According to one aspect of the present invention, there is provided a similarity determination system capable of detecting a slight difference in color or determining a certain color with high precision, which has been difficult to achieve when a conventional FA camera was used. With this feature, variation in the inspection accuracy is greatly reduced, which otherwise is caused if inspection is visually checked by a person.

Numerous additional modifications and variations are possible in light of the above teachings. It is therefore to be understood that within the scope of the appended claims, the disclosure of the present invention may be practiced otherwise than as specifically described herein. For example, elements and/or features of different illustrative embodiments may be combined with each other and/or substituted for each other within the scope of this disclosure and appended claims.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory cards, ROM (read-only-memory), etc. Alternatively, any one of the above-described and other methods of the present invention may be implemented by ASIC, prepared by interconnecting an appropriate network of conventional component circuits or by a combination thereof with one or more conventional general purpose microprocessors and/or signal processors programmed accordingly.

According to one aspect of the present invention, a similarity determination system is provided including: spectral information calculating means for calculating spectral information of an object from capturing information detected by imaging means, the object including 1) a reference item and 2) a target item being a subject for color determination; characteristic quantity transformation means for transforming the spectral information of the object being obtained by the spectral information calculating means into characteristic quantity; similarity determination criterion generation means for generating a similarity determination criterion from one or a plurality of items of the characteristic quantity of the reference item; and similarity determination means for checking the characteristic quantity of the target item that is a subject for color determination obtained by the characteristic quantity transformation means against the similarity determination criterion obtained by the similarity determination criterion generation means to determine similarity of the target item of the object with reference to the reference item.

More specifically, in one example, the similarity determination system may be implemented by an image capturing apparatus including a processor, which operates in cooperation with the imaging means such as an image capturing device. In another example, the similarity determination system may be implemented by an image capturing system, which includes an image capturing apparatus provided with the imaging means, and an information processing apparatus that communicates with the image capturing apparatus.

Further, in one example, when the similarity determination is in a teaching state, the similarity determination system includes: similarity determination spectral information calculating means for calculating spectral information of a reference item from capturing information detected by imaging means; characteristic quantity transformation means for transforming the spectral information of the reference item being obtained by the spectral information calculating means into characteristic quantity; similarity determination criterion generation means for generating a similarity determination criterion from one or a plurality of items of the characteristic quantity of the reference item; and storing means for storing the similarity determination criterion.

In another example, when the similarity determination system is in an operating state, the similarity determination system includes: similarity determination spectral information calculating means for calculating spectral information of a target item from capturing information detected by imaging means; characteristic quantity transformation means for transforming the spectral information of the target item being obtained by the spectral information calculating means into characteristic quantity; means for obtaining the similarity determination criterion from the memory; and similarity determination means for checking the characteristic quantity of the target item being a subject for color determination against the similarity determination criterion obtained by the similarity determination criterion generation means to determine similarity of the target item of the object with reference to the reference item.

According to one aspect of the present invention, a non-transitory recording medium storing a plurality of instructions is provided which, when executed by a processor, cause the processor to perform a method of determining similarity of an object, the method including: calculating spectral information of the object from capturing information detected by imaging means, the object including 1) a reference item and 2) a target item being a subject for color determination; transforming the calculated spectral information of the object into characteristic quantity; generating a similarity determination criterion from one or a plurality of items of the characteristic quantity of the reference item; and checking the characteristic quantity of the target item being a subject for color determination against the similarity determination criterion to determine similarity of the target item with reference to the reference item.

What is claimed is:

1. A similarity determination apparatus comprising:
a processor configured to:
calculate spectral information of an object from capturing information detected by an image capturing device, the object including 1) a reference item and 2) a target item being a subject for color determination;
transform the spectral information of the object into characteristic quantity;
generate a similarity determination criterion from one or a plurality of items of the characteristic quantity of the reference item of the object; and
check the characteristic quantity of the target item being a subject for color determination against the similarity determination criterion to determine similarity of the target item with reference to the reference item.

2. The similarity determination apparatus according to claim 1, wherein
the processor is configured to output an enclosing shape including the characteristic quantity of the reference item as the similarity determination criterion, and make a determination by determining whether the characteristic quantity of the target item is included within the enclosing shape.

3. The similarity determination apparatus according to claim 2, wherein
the enclosing shape is a circle or a polygon including the characteristic quantity of the reference item.

4. The similarity determination apparatus according to claim 2, wherein
when the characteristic quantity is N-dimensional, the enclosing shape is an N-dimensional sphere including the characteristic quantity of the reference item.

5. The similarity determination apparatus according to claim 2, wherein
when the characteristic quantity is N-dimensional, the enclosing shape is an N-dimensional polyhedron including the characteristic quantity of the reference item.

6. The similarity determination apparatus according to claim 3, wherein
the characteristic quantity is a color space coordinate value.

7. The similarity determination apparatus according to claim 6, wherein
the image capturing device comprises:
an optical system;
a sensor configured to convert optical information of lights focused on an image area by the optical system, into electronic information, the electronic information being input to the processor as the capturing information;
a filter arranged near a stop of the optical system, the filter having a plurality of spectral characteristics; and
a lens array having a plurality of lenses arranged between the optical system and the sensor substantially in parallel to a two-dimensional plane surface of the image sensor.

8. A similarity determination system comprising:
an image capturing apparatus; and
an information processing apparatus comprising a processor, the processor configured to:
calculate spectral information of an object from capturing information detected by the image capturing apparatus, the object including 1) a reference item and 2) a target item being a subject for color determination;
transform the spectral information of the object into characteristic quantity;
generate a similarity determination criterion from one or a plurality of items of the characteristic quantity of the reference item of the object; and
check the characteristic quantity of the target item being a subject for color determination against the similarity determination criterion to determine similarity of the target item with reference to the reference item.

9. The similarity determination system according to claim 8, wherein
the processor is configured to output an enclosing shape including the characteristic quantity of the reference item as the similarity determination criterion, and make a determination by determining whether the characteristic quantity of the target item is included within the enclosing shape.

10. The similarity determination system according to claim 8, wherein
the enclosing shape is a circle or a polygon including the characteristic quantity of the reference item.

11. The similarity determination system according to claim 8, wherein
when the characteristic quantity is N-dimensional, the enclosing shape is an N-dimensional sphere including the characteristic quantity of the reference item.

12. The similarity determination system according to claim 8, wherein when the characteristic quantity is N-dimensional, the enclosing shape is an N-dimensional polyhedron including the characteristic quantity of the reference item.

13. The similarity determination system according to claim 8, wherein the characteristic quantity is a color space coordinate value.

14. The similarly determination system according to claim 8, wherein the image capturing apparatus comprises:
an optical system;
a sensor configured to convert optical information of lights focused on an image area by the optical system, into electronic information, the electronic information being sent to the information processing apparatus as the capturing information;
a filter arranged near a stop of the optical system, the filter having a plurality of spectral characteristics; and
a lens array having a plurality of lenses arranged between the optical system and the sensor substantially in parallel to a two-dimensional plane surface of the image sensor.

15. A method of determining similarity of an object, the method comprising:
calculating spectral information of the object from capturing information detected by an image capturing device, the object including 1) a reference item and 2) a target item being a subject for color determination;
transforming the calculated spectral information of the object into characteristic quantity;
generating a similarity determination criterion from one or a plurality of items of the characteristic quantity of the reference item of the object; and
checking the characteristic quantity of the target item being a subject for color determination against the similarity determination criterion to determine similarity of the target item with reference to the reference item.

16. The method according to claim 15, further comprising:
outputting an enclosing shape including the characteristic quantity of the reference item as the similarity determination criterion, wherein the checking includes:
determining whether or not the characteristic quantity of the target item is included within the enclosing shape.
